(19) United States
(12) Patent Application Publication
(10) Pub. No.: US 2010/0044471 A1
(43) Pub. Date: Feb. 25, 2010

(54) Fuel injector with energy adsorbing pole

(76) Inventor: Raul A. Bircann, Penfield, NY (US)

Correspondence Address: Delphi Technologies, Inc., M/C 480-410-202, PO BOX 5052, Troy, MI, 48007, US

(21) Appl. No.: 12/229,384

(22) Filed: Aug. 22, 2008

(51) Int. Cl. B05B 1/30

(52) U.S. Cl. 239/585.4

(57) ABSTRACT

A solenoid operated gaseous fuel injector includes a pole positioned axially movable within a fuel tube, a retaining ring axially retaining a first end of the pole, a spring element positioned in contact with a second end of said pole, and an armature transmitting a force onto said pole at impact. The gaseous fuel injector operates to effectively attenuate and dissipate armature impact force onto the pole. Accordingly, impact energy attenuation is attained while cold temperature stiction of the moving parts is avoided.

### TECHNICAL FIELD

The present invention relates to fuel injection systems of internal combustion engines utilizing alternative fuels; more particularly, to solenoid actuated fuel injectors for gaseous fuels; and most particularly, to a compressed natural gas fuel injector including a compliant pole and a method for attenuation of mechanical energy within a gaseous fuel injector.

### BACKGROUND OF THE INVENTION

Escalating gasoline cost and ever-tightening emission regulations have instigated tremendous interest in compressed natural gas (CNG) as a viable fuel for automotive applications. Natural gas is an inherently clean-burning fuel that is domestically available, is drawn from gas wells or in conjunction with crude oil production. CNG is made by compressing natural gas, which is mostly composed of methane. CNG offers several tangible advantages over common liquid fuels, such as gasoline or diesel, in terms of cost/BTU (British thermal unit) and carbon dioxide emissions. Operating savings of 50% or more of an engine fueled by CNG is possible compared to a typical gasoline engine, particularly at today's gasoline cost. Carbon dioxide reductions of more than 30% are attainable over gasoline and other currently used liquid fuels. Tests have also shown that a reduction in carbon monoxide, nitrogen oxide emissions, and non-methane hydrocarbon emissions and elimination of evaporative emissions is possible through the use of CNG instead of gasoline. Still further, fewer toxic and carcinogenic pollutants and little or no particulate matter may be emitted when CNG is used as fuel. Therefore, a dramatic increase in the CNG vehicle world volume can be expected over the next several years.

While the use of CNG as an alternative fuel is desirable, CNG poses some unique challenges in automotive applications, particularly regarding fuel injector durability. Being a gaseous fuel, CNG lacks beneficial damping and lubricating properties inherent to liquid fuels. Consequently, impact velocity and energy go largely undissipated, which results in the generation of high and concentrated impact stresses, objectionable operating noise, and excessive performance deterioration of the injector contact surfaces from wear. For example, imparted stresses often result in severe deformation, particularly of the pole-armature interface of solenoid actuated CNG injectors. Such deformation has been observed to cause anomalous performance and intolerable flow shifts of a CNG injector.

Currently, injectors derived directly from liquid fuel injectors are typically used in CNG internal combustion engines. Appreciable problems have been experienced with such derivative injectors based on significantly shortened durability and excessive noise compared to their operation with liquid fuels. Some current CNG fuel injector designs have attempted to address these concerns through the employment of soft elastomeric interfaces in the valve mechanism. However, these methods have proven to be largely ineffective, as they have shown susceptibility to cold temperature stiction and long-term deterioration from repeated impact cycling. Cold temperature stiction, a resultant of emulsified residual moisture, compressor oil, and other contaminants severely impair operation of the injector at temperatures below about 10° C. Consequently, applicability of such fuel injectors may be very limited and may preclude widespread usage in many climates.

What is needed in the art is a viable solution to minimize the undesirable attributes associated with CNG fuel, particularly regarding the fuel injector.

It is a principal object of the present invention to provide a fuel injector suitable for use with CNG that displays energy attenuating and dissipating properties, is not susceptible to cold temperature stiction, and offers long-term wear resistance.

### SUMMARY OF THE INVENTION

Briefly described, a gaseous fuel injector has compliance incorporated into the pole design. Such compliance is attained by designing the pole to be a close-tolerance slip-fit to the fuel tube, thereby permitting a controlled amount of relative axial motion with a relatively small radial degree of freedom of the pole within the fuel tube, instead of being welded to the fuel tube as typical for prior art designs. The pole is held in position, axially, by a retainer near the pole's frontal face adjacent to the armature such that a prescribed overlap of the retainer by the pole's frontal face is realized. Such overlap may be tailored to reasonably maximize the impulse at impact of the pole with the armature, to minimize transmitted force, and to reduce impact stress. At the distal pole end, a spring element loads the pole against the retainer toward the armature. A pre-load of the spring element against the pole is selected to dissipate the impact energy of the armature striking the pole at the pole/armature interface.

The gaseous fuel injector in accordance with the invention operates to effectively attenuate and dissipate armature impact force onto the pole. The inherent restoring rate of the spring element controllably decelerates the moving mass of the armature, thereby diminishing the impact force. Inherent damping resulting from the spring-mass arrangement allows the pole and armature to quickly come to rest after impact.

The spring element in accordance with the invention may be of any design and of any flexible elastic material capable of storing mechanical energy such as, for example, a coil spring, a wave washer, or an elastomeric ring/spring.

Impact energy attenuation of an injector, in accordance with the invention, is attained while critical metallic impacting interfaces of the armature and the pole are retained. As a result, cold temperature stiction can be avoided. Furthermore, since metals are dimensionally more stable than polymer materials, critical clearances between the moving parts of the injector can be precisely maintained.

### BRIEF DESCRIPTION OF THE DRAWINGS

The present invention will now be described, by way of example, with reference to the accompanying drawings, in which:

FIG. 1 is a cross-sectional view of a prior art gasoline fuel injector;

FIG. 2 is a cross-sectional view of a gaseous fuel injector employing a first type of a spring element in accordance with the invention; and

FIG. 3 is a cross-sectional view of the gaseous fuel injector employing a second type of the spring element in accordance with the invention.

Corresponding reference characters indicate corresponding parts throughout the several views. The exemplification set out herein illustrates preferred embodiments of the invention, in one form, and such exemplification is not to be construed as limiting the scope of the invention in any manner.

### DESCRIPTION OF THE PREFERRED EMBODIMENTS

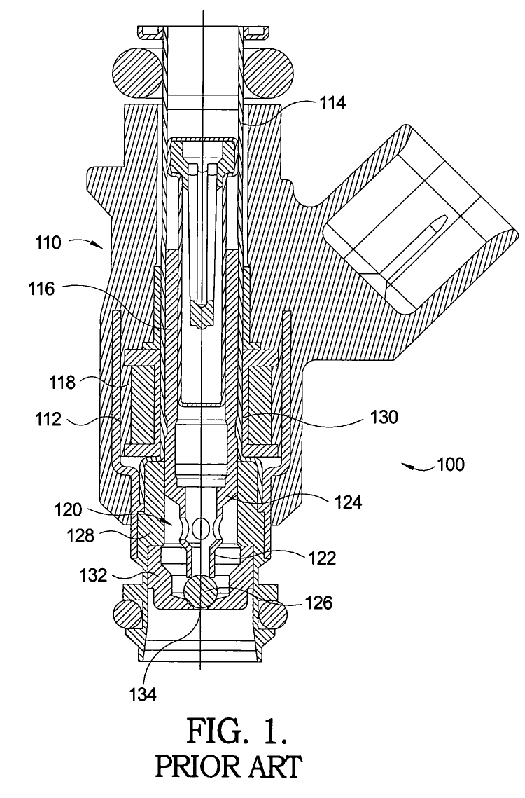

Referring to FIG. 1, a typical prior art gasoline fuel injector 100 consists of two primary sub-assemblies; an actuator sub-assembly 110 and a metering sub-assembly 120. Actuator sub-assembly 110 includes a self-contained solenoid 112, which is slipped over a fuel tube 114 and welded to a metering body 128. A pole 116 is secured to fuel tube 114, for example by welding, typically in an area proximate to the center of solenoid 112 and particularly at the longitudinal axis of a coil 118, to maximize flux linkage and force. As a result, pole 116 is in a fixed connection with fuel tube 114. Pole 116 is preferably made from a material within the steel family that has relatively good magnetic properties, as known in the art. Metering sub-assembly 120 is assembled within metering body 128 and includes a valve shaft 122 having an armature 124 attached at one end and a valve 126 at the opposite end. An axially gap also referred to as valve lift 130 is set to define the total length of the axial travel/lift of metering sub-assembly 120 in response to a voltage applied to solenoid 112, whereupon a magnetic field results that creates attractive forces between pole 116 and armature 124. The lift 130 of metering sub-assembly 120 coupled with an applied pressure differential across valve 126 results in a desired fuel flow past a valve seat 132 and through a discharge orifice 134. The size of pole 116 and of armature 124 is typically limited by the available force and the engine space. Armature 124 is preferably formed from stainless steel.

Typical automotive internal combustion engines desirably operate stoichiometrically near a mass air/fuel ratio of about 14.7/1. Since the density of a gaseous fuel, such as CNG, is significantly less than that of gasoline or other typically used liquid fuels, operating pressure and valve lift 130 must be significantly higher for a gaseous injector to deliver a similar amount of mass fuel in a similar time duration as a liquid fuel injector. While the flow area proximate to discharge orifice 134 could be increased, this is typically avoided due to an increase of parasitic forces proportional to the square of the seal diameter. As a result, to deliver an equal amount of fuel mass, typically valve lift 130 is increased. However, since an equal amount of fuel mass must be delivered to the engine within the same time duration when using a gaseous fuel, armature velocities must be significantly greater for a gaseous fuel injector compared to a similar capacity liquid fuel injector. Thus, since kinetic energy is proportional to the velocity squared of a moving object, a substantial increase in impact energy in a gaseous fuel injector results. Since an armature and a coil of a gaseous fuel injector typically would be limited to similar size and material restrictions as a typical prior art liquid fuel injector, an increase of the impact force of the armature on the pole occurs. Consequently, repetitive impact cycling may result in surface distortion and deterioration and/or ultimate breakage at the armature/pole interface, as a form of energy dissipation. Therefore, a gaseous fuel injector in accordance with the invention is proposed where the mass impact energy is managed by providing energy attenuation and energy dissipating possibilities that enable long-term wear resistance without introducing susceptibility to cold temperature stiction.

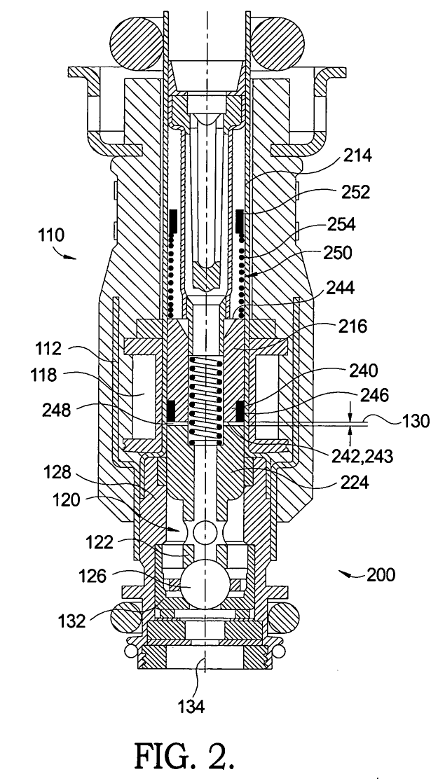

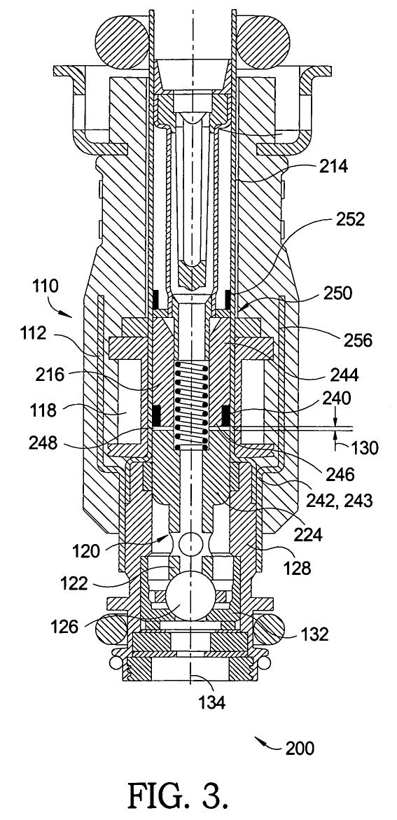

Referring to FIGS. 2 and 3, a fuel injector 200 for metering a gaseous fuel, such as CNG, into a combustion chamber of an internal combustion engine is fundamentally similar in configuration to the prior art gasoline fuel injector 100 as shown in FIG. 1. Accordingly, features identical with those in prior art gasoline fuel injector 100 carry the same numbers; features analogous but not identical carry the same numbers but in the 200 series.

Gaseous fuel injector 200 has compliance incorporated into the design of a pole 216. Such compliance is attained by eliminating the fixed connection between pole 216 and fuel tube 214, and by enabling pole 216 to axially move within fuel tube 214. Axially movement of pole 216 within fuel tube 214 is enabled, for example, by designing the outer circumferential contour of pole 216 to have a close-tolerance slip fit relative to the inner circumferential contour of fuel tube 214, where pole 216 has a relatively small radial degree of freedom. The clearance between the outer circumferential contour of pole 216 and the inner circumferential contour of fuel tube 214 may be, for example, similar to the clearance between pole 116 and fuel tube 114 of fuel injector 100 (as shown in FIG. 1) prior to the welding process.

Instead of providing a fixed connection between pole 216 and fuel tube 214, pole 216 is axially retained in one direction within fuel tube 214 by a stop such as retaining ring 240. Retaining ring 240 fixed in place to fuel tube 214, for example by a welding process. Retaining ring 240 is preferably assembled within fuel tube 214 after a valve lift 130 has been set. Pole 216 extends axially from a first end 242 proximate armature 224 to a second end 244 opposite the first end. Pole 216 includes a step 246 at first end 242 adapted to mate with retaining ring 240. The axial dimensions of step 246 and retaining ring 240 are designed such that a nose 243 of first end 242 of pole 216 extends through retaining ring 240 when in a retained position thereby forming a prescribed overlap 248 at first end 242. Proximate to second end 244 of pole 216, a spring element 250 is placed within fuel tube 214 with one end of the spring element in contact with pole 216. The other end of spring element 250 may be axially positioned by a spring retainer 252 fixed to fuel tube 214, for example by welding and/or press fitting. The axial position of spring retainer 252 relative to the fuel tube sets the preload of spring element 250 on pole 216 to achieve a desired attenuation of the upwards movement of pole 216 and force dissipation. Spring element 250 may be, for example a typical coil spring 254, as shown in FIG. 1 or a wave washer 256, as shown in FIG. 2. All though not illustrated, spring element 250 may also be an elastomeric ring or any other device suitable for attenuation of upward movement of pole 216.

By permitting a controlled amount of resistive axial movement of pole 216 within fuel tube 214, the impact force of armature 224 on pole 216 can be effectively attenuated and dissipated. The inherent restoring rate of spring element 250 decelerates the moving mass of armature 224 by increasing the time of contact between armature 224 and pole 216 upon impact, thereby diminishing the impact force. After making contact with pole 216, armature 224 and pole 216 continue to move upward in tandem against the force of spring element 250 until armature 224 is stopped by retaining ring 240. Pole 216 may continue to move against spring element 250. Once pole 216 is contacted at first end 242 by upward moving armature 224, kinetic energy is transferred from armature 224 to pole 216. Inherent energy damping by the moving pole causes armature 224 to come to a relatively quick but not sudden stop. Therefore, the length of overlap 248 is selected to optimize both the damping effect of the axially movable pole and the opening time of the injector.

As can be seen by comparing gaseous fuel injector 200 as shown in FIGS. 2 and 3 with prior art liquid fuel injector 100 as shown in FIG. 1, the novel elements in accordance with the invention, such as axially movable pole 216, retaining ring 240, spring element 250, and spring retainer 252, may be readily retrofitted into an existing prior art fuel injector with little or no modification to injector components. By forming armature 224 and pole 216 of injector 200 from metallic materials similarly used for armature 124 and pole 116 of prior art gasoline fuel injector 100, cold temperature stiction caused by the use of polymers as interfacing materials, can be avoided. Moreover, better dimensional stability enjoyed by the metallic materials may be realized.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A solenoid operated fuel injector, comprising:
a pole positioned axially movable within a fuel tube, said pole axially extending from a first end to a second end;
a stop fixed to said fuel tube, wherein said first end of said pole extends through said stop forming an overlap;
a spring element biasing said pole toward said stop; and
an armature transmitting a force onto said pole at impact with said overlap.

2. The fuel injector of claim 1, wherein said stop is in a ring fixed to said fuel tube.

3. The fuel injector of claim 1, wherein said pole includes a step proximate to said first end, wherein said step is adapted to mate with said stop and to form said overlap.

4. The fuel injector of claim 1, further including a spring retainer for axially containing said spring element, wherein said spring retainer is in a fixed connection with said fuel tube.

5. The fuel injector of claim 1, wherein a pre-load is applied to said spring element.

6. The fuel injector of claim 1, wherein said spring element is a coil spring.

7. The fuel injector of claim 1, wherein said spring element is a wave washer.

8. The fuel injector of claim 1, wherein said spring element is an elastomeric ring.

9. The fuel injector of claim 1, wherein said armature is formed from stainless steel, and wherein said pole is formed from steel that exhibits magnetic properties.

10. The fuel injector of claim 1, wherein a fuel injected by said fuel injector is a gaseous fuel.

11. The fuel injector of claim 10 wherein said gaseous fuel is compressed natural gas.

12. An injector for injection of compressed natural gas in an internal combustion engine, comprising:
a solenoid surrounding a fuel tube;
a pole positioned axially movable within said fuel tube;
a stop positioning said pole within said fuel tube;
an armature axially moving towards said pole in response to a voltage applied to said solenoid, wherein said armature transmits a force onto said pole at impact; and
a spring element biasing said pole toward said stop wherein said spring element attenuates said force.

13. The fuel injector of claim 12, wherein said pole includes a step proximate an end proximate said armature, wherein said stop mates with said step, and wherein said step enables said pole to partially extend beyond said stop to make contact with said armature.

14. The fuel injector of claim 12, wherein a spring retainer axially retains said spring element within said fuel tube, and wherein said spring retainer applies a pre-load to said spring element.

15. The fuel injector of claim 12, wherein said armature and said pole are formed from a metallic material.

16. A method for attenuating impact energy within a fuel injector of an internal combustion engine, comprising the steps of:
positioning a pole axially movable within a fuel tube;
axially stopping said pole within said fuel tube in one direction with a stop such that a first surface of said pole extends through said stop;
moving an armature towards said pole in response to a voltage applied to a solenoid surrounding said fuel tube proximate said pole;
transmitting a force onto said pole at impact of said armature with said first surface of said pole; and
attenuating said force with spring element biasing said pole toward said stop.

17. The method of claim 16, further including the steps of:
forming said armature from a metal suitable for a gaseous fuel environment; and
forming said pole from a metal having magnetic properties.

18. The method of claim 16, further including the steps of:
incorporating a step into said pole for mating with said stop;
designing said step to create a prescribed overlap of said pole relative to said stop for optimizing said impact energy attenuation.
